(19) United States
(12) Patent Application Publication
(10) Pub. No.: US 2011/0176723 A1
(43) Pub. Date: Jul. 21, 2011

(54) Motion Correction in Cone-Beam CT by Tracking Internal and External Markers Using Cone-Beam Projection From a kV On-Board Imager: Four-Dimensional Cone-Beam CT and Tumor Tracking Implications

(75) Inventors: Imad Ali, Edmond, OK (US); Salahuddin Ahmad, Edmond, OK (US); Terence Herman, Edmond, OK (US)

(73) Assignee: BOARD OF REGENTS UNIVERSITY OF OKLAHOMA, Norman, OK (US)

(21) Appl. No.: 13/007,934

(22) Filed: Jan. 17, 2011

Related U.S. Application Data
(60) Provisional application No. 61/295,352, filed on Jan. 15, 2010.

(51) Int. Cl. G06K 9/00

(52) U.S. Cl. 382/154

(57) ABSTRACT

An apparatus comprising a processor configured to receive a sequence of Cone-Beam Computed Topology (CBCT) projections of a three dimensional (3D) object over a scanning period, wherein the 3D object is displaced during the scanning period, and wherein each of the CBCT projections is associated with a discrete point during the scanning period, locate a marker position in a plurality of the CBCT projections, wherein each marker position corresponds to the location of an internal marker at the corresponding discrete point during the scanning period, extract a 3D motion trajectory based on the plurality of marker positions and a plurality of time-tagged angular views, and correct the CBCT projections based on the 3D motion trajectory.

### CROSS-REFERENCE TO RELATED APPLICATIONS

The present application claims the benefit of U.S. Provisional Patent Application No. 61/295,352 filed Jan. 15, 2010 by Imad Ali, et al. and entitled “Motion Correction in Cone-Beam CT by Tracking Internal and External Markers Using Cone-Beam Projection from a kV On-Board Imager Four-Dimensional Cone-Beam CT and Tumor Tracking Implications”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Various medical imaging techniques may be employed by physicians during clinical examination to view a patient's internal structures, e.g. organs, bones, etc. Radiography may be one medical imaging technique that comprises observing the attenuation of a beam of electromagnetic radiation, e.g. composed of X-Rays, as it passes through a patient. X-rays may be electromagnetic waves comprising a wavelength between about 0.01 and about 0.1 nanometers (nm), and may have a relatively high-energy content, e.g. when compared with visible light. Due to their high-energy content, X-rays may penetrate some solid objects (e.g. human tissue) that would otherwise completely attenuate visible light, while still being partially or completely attenuated (e.g. absorbed or reflected) by other denser objects (e.g. bone, organs, etc.). As such, observing the attenuation of an X-ray beam as it passes through a patient may enable physicians and other medical professionals to view various parts of the patient's internal structure, e.g. bones, teeth, various organs, etc.

Computed tomography (CT), also known as computed axial tomography (CAT), may be one radiographic application that uses computer processing to generate a three dimensional (3D) representation (volumetric or otherwise) of the patient's internal structure from a series of two dimensional (2D) X-ray images. Hence, a CT scan may generate a 3D image of a patient's internal structure, thereby allowing the patient's physician to examine the region in greater detail than would otherwise be available from a standard 2D X-ray image. CT scans are generally performed by either a conventional CT or a Cone-beam CT (CBCT) scanning procedure, also known as a conventional CT scan or a CBCT scan (respectively). Conventional CT scans may comprise rotating an X-ray source positioned about opposite, e.g. about 180°, from a one dimensional (1D) array of detectors around the patient along a singular axis, e.g. the patient's craniocaudal axis. A conventional CT scanner's X-ray source may emit a flat fan-shaped beam, which may be monitored continuously by the 1D array of detectors as it passes through the patient at various angles. The data generated during the about 360° rotation may be used to produce a 2D image (slice) along the examined cross-sectional plane. Once the rotation is complete, the source and detector may be shifted axially so that another cross-sectional plane may be examined. This process may be repeated until the entire region under examination, e.g. torso, cranium, etc., has been scanned into a sequence of slices. Hence, a conventional CT scan may comprise numerous scanning periods of relatively short duration, e.g. about one second each. Ultimately, the resulting sequence of slices may be processed, e.g. stacked and interpolated, during CT reconstruction to produce a CT image of the region under examination.

Conversely, CBCT scans may comprise rotating an X-ray source positioned about opposite, e.g. about 180°, from a 2D array of detectors (a flat-panel detector) around the patient along a helical or spiraled trajectory. The CBCT scanner's X-ray source may emit a conical or cone-shaped beam (e.g. rather than a flat fan-shaped beam), which may be monitored by the flat-panel detector at discrete points, e.g. observation angles, along the helical trajectory. For instance, one projection of the conical beams attenuation may be captured by the flat-panel detector at each discrete observation angle, such that a sequence of CBCT projections, e.g. periodic snapshots of the conical X-ray beam's attenuation, may be generated along the CBCT scanner's helical trajectory. For example, some CBCT scans may generate about 650 frames per CBCT scanner revolution (e.g. about 360° of rotation), or about two frames per degree of CBCT scanner rotation. Hence, CBCT scans may comprise one scanning period of relatively long duration, e.g. about one minute. The resulting sequence of projections may be processed, e.g. using CBCT reconstruction algorithms, to construct a CBCT image of the examined region. Although CBCT reconstruction may entail more complex computations when compared with conventional CT reconstruction, CBCT scans using multiple-array or flat-panel detectors may be generally preferred over conventional CT scans due to higher spatial resolution, a shorter overall scanning period and/or reduced patient radiation exposure.

### SUMMARY

In one embodiment, the disclosure includes an apparatus comprising a processor configured to receive a sequence of CBCT projections of a 3D object over a scanning period, wherein the 3D object is displaced during the scanning period, and wherein each of the CBCT projections is associated with a discrete point during the scanning period, locate a marker position in a plurality of the CBCT projections, wherein each marker position corresponds to the location of an internal marker at the corresponding discrete point during the scanning period, extract a 3D motion trajectory based on the plurality of marker positions and a plurality of time-tagged angular views, and correct the CBCT projections based on the 3D motion trajectory.

In another embodiment, the disclosure includes a method comprising performing a CBCT scan of a 3D object during a scanning period to produce a plurality of CBCT projections, wherein each CBCT projection comprises a snapshot of the 3D object taken from a unique view angle at a discrete point during the scanning period, and wherein the 3D object moves during the scanning period, tracking the movement of a first internal marker over the scanning period, wherein the first internal marker is within the 3D object, and wherein the movement of the first internal marker corresponds with the movement of the 3D object during the scanning period, correcting each CBCT projection based on the movement of the first internal marker at the corresponding discrete point during the scanning period; and reconstructing a CBCT image using the corrected CBCT projections.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIGS. 1(a)-(c) are schematic diagrams of a CBCT projection apparatus with the geometric relationship between patient and imaging system coordinates.

FIG. 2 is a flowchart of an embodiment of a method for extracting 3D motion trajectories from CBCT projections.

FIGS. 3(a)-(b) are graphs of the positions of three stationary and mobile voxels (A,B,C) on CBCT projections.

FIGS. 4(a)-(d) are graphs of the two-dimensional positions of three stationary and mobile voxels (D,E,F) and the displacements due to a simple sinusoidal motion on CBCT projections.

FIGS. 5(a)-(c) are graphs of filtering displacements in the three-dimensions (X,Y,Z) of a moving voxel.

FIGS. 6(a)-(b) are images generated from a CBCT projection and an axial slice.

FIGS. 6(c)-(d) are graphs of motion tracks of markers obtained from CBCT projections.

FIGS. 7(a)-(c) are graphs of motion tracks of external and internal markers generated from CBCT scans.

FIGS. 8(a)-(f) are axial, coronal and saggittal images generated from CBCT reconstruction before and after motion correction.

FIGS. 9(a)-(b) are axial images generated from CBCT reconstruction before and after motion correction for a lung patient.

FIG. 10 is a schematic diagram of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

CBCT and conventional CT reconstruction techniques may assume that the patient has remained static during the scanning period, e.g. that the absolute position of the patient has not changed. However, patient motion resulting from voluntary patient relaxation and/or involuntary organ motion, e.g. respiration, cardiac cycle, digestion, etc., may be unavoidable during the scanning period, and in some cases may significantly reduce imaging quality. Conventional CT scans generally comprise multiple scanning periods of relatively short duration, e.g. about one second each, while CBCT scans generally comprise a single scanning period of relatively long duration, e.g. about one minute. Consequently, patient motion may be relatively less substantial during the abbreviated conventional CT scanning periods, and may result in only minor motion related image artifacts in the individual slices. Conversely, patient motion may be relatively more substantial during the extended CBCT scanning period, and may result in significant motion related image artifacts in the reconstructed CBCT image, e.g. including blurring, spatial distortion, poor contrast, and reduced resolution. For instance, the average free breathing patient may experience between about 10 and about 20 respiratory cycles in a CBCT scanning period. Consequently, motion related image artifacts may limit the value of CBCT as a medical imaging tool for applications requiring enhanced positioning accuracy, e.g. stereotactic body radiation and/or intensity-modulated radiation therapy both of which may rely on delivering large conformal doses of radiation to a targeted tumor with precision. In such situations, treatment margins needed to correct for respiratory motion may depend largely on imaging accuracy, and poor imaging accuracy may result in larger planning target volumes (PTVs), e.g. encompassing more healthy tissue and/or critical structures, to ensure eradication of the targeted tumor.

Several conventional CT scanning techniques have been developed to reduce motion related image artifacts in CT images, e.g. faster gantry rotation resulting in even shorter CT scanning periods, multi-slice technology resulting in scanning larger thickness within a short period of time, etc. However, these CT scanning techniques may be incompatible with (or produce limited benefits in) on-board CBCT scanning due to inherent differences between the two radiographic imaging techniques. Additionally, a number of conventional image processing techniques have been applied to retrospectively correct motion related artifacts in the 2D projections prior to CT construction, e.g. adaptive interference cancellation, pixel specific back-projection to reduce doubling and/or streaking artifacts, etc. However, the effectiveness of these conventional image processing techniques may be limited in CBCT scanning applications due to the CBCT's extended scanning period, more significant motion related image artifacts, or combinations thereof.

One technique that has been applied more successfully to CBCT scanning applications may be real-time position management (RPM), which may correct correlated groups of CBCT projections according to a uniform motion for the corresponding patient respiratory cycle. Specifically, the patient's respiratory cycle may be monitored during the CBCT scan using an external marker attached to the patient's skin, and the projections may be divided into one or more correlated groups (e.g. phase groups) based on the phase of the patient's respiratory cycle. For instance, the patient's respiratory cycle may be divided into three phases, which are designated based on the external marker's position along the Y-axis. Projections taken during a first respiratory phase (e.g. external marker's position<Y1) may be grouped together, projections taken during a second respiratory phase (e.g. Y1<external marker's position<Y2) may be grouped together, and projections taken during a third respiratory phase (e.g. external marker's position>Y2) may be grouped together (e.g. where Y1 and Y2 are boundaries on the Y-axis). Projections then may be adjusted according to phase group, such that all projections in the respective phase groups are shifted by a uniform amount. However, RPM only monitors the external marker's displacement along the Y-axis (i.e. in the anterior-posterior direction), and therefore is incapable of extracting 3D motion trajectories. Further, the external marker may be only somewhat correlated to patient internal tumor respiratory motion, and therefore the projections may be grouped imprecisely at different phase from internal patient motion. Lastly, RPM corrects CBCT projections based on phase-based transformations (e.g. one generic transformation is used for multiple projections), and hence may lack adequate granularity when motion shifts vary greatly between CBCT projections within the same phase group. As such, RPM may not be sufficient for some applications, e.g. applications requiring high levels of precision, thus a more effective technique for reducing motion related artifacts in CBCT is needed.

Disclosed herein is a method for retrospectively correcting CBCT projections according to an extracted 3D motion trajectory of an internally implanted marker, thereby reducing or eliminating motion related image artifacts in reconstructed CBCT images. Specifically, the method may comprise positioning one or more internal markers in and/or around a region of interest (ROI), e.g. a tumor or lesion area, prior to CBCT scanning. Subsequently, a CBCT scan may be performed to generate a series of CBCT projections capturing the ROI from various angles (e.g. time-tagged angular views). Next, at least one of the internal markers may be located in some or all of the CBCT projections, such that a 2D mobile track of the internal marker's actual projected position (e.g. as a function of view angle) may be generated. Thereafter, a 2D stationary track of the marker's ideal projected position (e.g. as a function of view angle) then may be computed by applying a non-linear curve fitting algorithm to the 2D mobile track. In some embodiments, the 2D stationary track may correspond to the internal marker's ideal projected position, e.g. irrespective of any shifts due to patient motion, while the 2D mobile track may correspond to the internal marker's actual projected position, e.g. including any shifts due to patient motion. Next, a 3D motion trajectory may be extracted based on differences between the 2D mobile track and the 2D stationary track. The 3D motion trajectory may correspond to the marker's 3D displacement over the course of the scanning period, and may be used to remap some or all of the pixels in each of the CBCT projections, thereby producing motion-corrected CBCT projections. Finally, CBCT reconstruction may be performed using the motion-corrected CBCT projections to produce a motion-corrected CBCT image. Additionally, one or more of the features of this disclosure, e.g. correlated internal and external marker 3D motion trajectories, may be used to perform four dimensional (4D) CBCT (4D-CBCT), beam gating, and/or tumor motion monitoring/tracking, as well as other CBCT scanning functions.

CBCT scanners may comprise an on-board-imager (OBI) fixed to a rotating gantry, as well as other necessary components such as a treatment couch. The OBI may be any device configured to produce radiographic images during a CBCT scan. The gantry may be any device employed to control the path and/or trajectory of the OBI during the CBCT scan, and may comprise various components for supporting and/or manipulating the OBI, e.g. robotic support arms mounted on a linear accelerator (linac). The gantry, or components thereof, may be commercially available from various manufacturers, such as Varian Medical Systems.

The OBI may comprise an assortment of components used to generate radiographic images, such as an X-ray source and a flat-panel detector. The X-ray source may comprise any component or apparatus capable of emitting a beam of electromagnetic radiation, e.g. a conical X-ray beam, through a patient or object in a controlled manner, e.g. a diagnostic quality kilovolt (Kv) X-ray source. The flat-panel detector may comprise any component or apparatus capable of observing the X-ray beam's attenuation as it passes through an object, such as a patient or phantom (e.g. a device used to replicate patient motion for CT scanning evaluation purposes). For instance, the flat panel detector may comprise a matrix of picture elements (pixels), e.g. a 1024×768 pixel array, such that each pixel has a unique position, e.g. (j, k), on the flat-panel detector. Each pixel may be assigned an integer value, e.g. 0, 1, . . . or N−1 (N is an integer), that represents an image quality or characteristic, such as a grayscale intensity, at the corresponding reference point. The flat-panel display may comprise different design characteristics depending on the application, such as various bit-depths, e.g. eight-bit depth, sixteen-bit depth, etc., and/or adjustable frame rates, e.g. between seven and ten projections per second. In an embodiment, the OBI's X-ray source and flat panel display may be positioned about opposite from one another, e.g. the X-Ray source having a 180° angular displacement from the flat-panel detector, such that the X-ray source's conical beam is projected onto the flat-panel detector at all times during the scanning period. The OBI's X-ray source and flat-panel detector may be the same or different distances away from the patient's isocenter, e.g. the point in space through which the central ray of the radiation beams passes. For instance, the X-ray source may be 100 cm from the patient's isocenter, while the flat-panel detector may be 50 cm from the patient's isocenter.

The OBI may be configured to generate a series of 2D radiographic projections (CBCT projections) as its conical beam is rotated around the object along a circular and/or helical trajectory. Each projection may comprise a snapshot of the X-ray beam's attenuation as it passes through the object at a unique view angle. In some embodiments, the OBI may generate about 650 projections per 360° of gantry rotation (e.g. or about two projections per gantry angle), which may be collected over a scanning period of about one minute (e.g. the approximate time required for one full gantry rotation). The OBI may comprise a number of scanning modes, e.g. full-fan (FF) scanning mode, half-fan (HF) scanning mode, etc, having varying fields of view (FOV) and/or spatial resolution characteristics. For instance, the OBI may be set to FF scanning mode, e.g. having a FOV diameter of a about 25 cm and thickness of about 17 cm, to examine a smaller volumetric area at an increased spatial resolution, or alternatively the OBI may be set to HF scanning mode, e.g. having a FOV diameter of about 45 cm and thickness of about 15 cm, to examine a larger volumetric area at a decreased spatial resolution. In some embodiments, HF scanning mode may only capture about half of the ROI in any one projection (with different projections capturing different portions of the ROI).

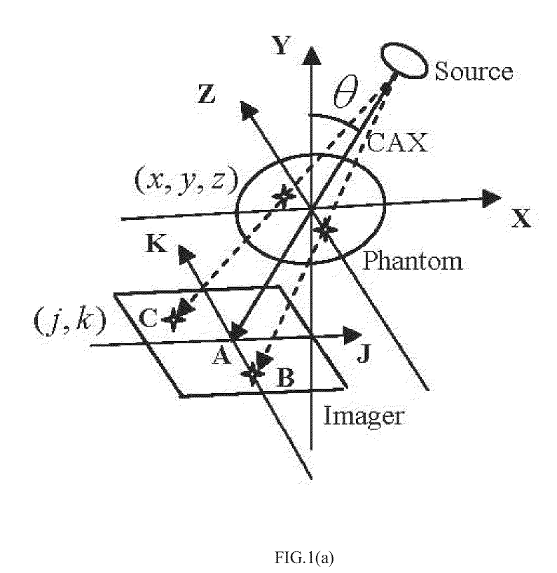

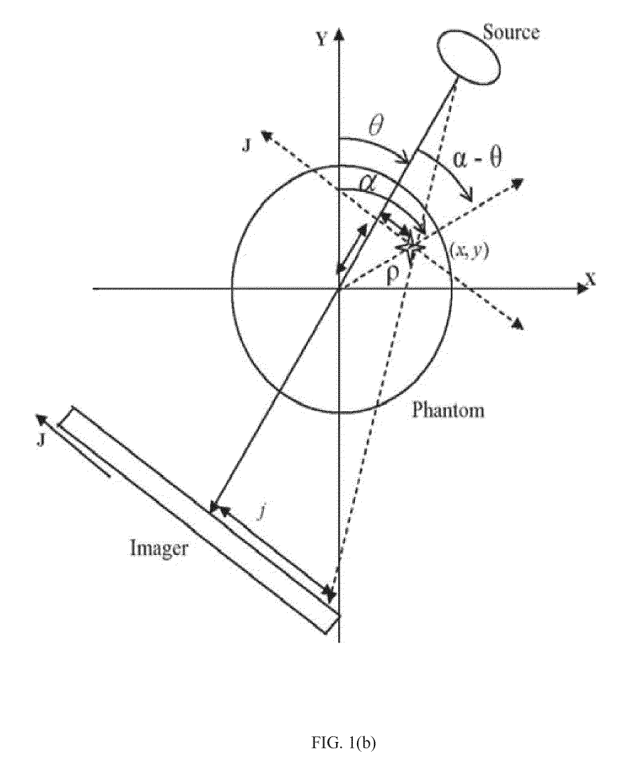

During imaging, the CBCT scanner may assume that the patient is composed of a plurality of discrete volumetric picture elements (voxels) of uniform size, e.g. about 0.26 millimeter (mm) at isocenter, with each voxel having a unique position, e.g. (x, y, z), within the examined spatial region. As illustrated in FIG. 1(a), the X-Ray source's conical beam may be directed through an object, e.g. phantom, at a unique view angle (A), thereby projecting each patient voxel, e.g. (x, y, z), onto the flat-panel imager at a corresponding pixel location, e.g. (j, k). The patient's isocenter may be represented by voxel (0, 0, 0), which may be projected onto the flat-panel imager at the corresponding pixel location (0,0). A first 3D marker, e.g. positioned at voxel (0, 0, z), and a second 3D marker, e.g. positioned at voxel (x, y, 0), may be projected onto the flat-panel imager as marker B, e.g. located at pixel (0, k), and marker C, e.g. located at pixel (j, k), (respectively).

FIGS. 1(b) and 1(c) illustrate a schematic diagram of geometric relationships occurring between a markers' 3D position, e.g. at voxel (x, y, z), and the corresponding projection's 2D position, e.g. at pixel (j, k), as the marker is projected onto the flat-panel detector/imager. Specifically, FIG. 1(b) illustrates the geometric relationship occurring between the marker's 3D position in the superior-inferior direction (Z-direction) and the corresponding projection's 2D position along the K-axis (e.g. the pixel component k). FIG. 1(c) illustrates the geometric relationship occurring between the marker's 3D position in a plane perpendicular to the superior-inferior direction (X-Y plane) and the corresponding projection's 2D position along the J-axis. Using the similarity of triangles in FIG. 1(b), the relationship between the projection's 2D position along the J-axis (j) and the marker's radial distance in the X-Y plane (ρ) is given by:

$$\frac{SAD - ρ cos ( α - θ )}{SID} = \frac{ρ sin ( α - θ )}{j} \qquad ( 1 )$$

where ρ=r sin(β)=\sqrt{x²+y²}, r=\sqrt{x²+y²+z²}, θ is the projection view angle,

$$α = {tan}^{- 1} ( \frac{x}{y} )$$

is the polar angle (e.g. the angle which depends on the location of the patient voxel projection in X-Y plane),

$$β = {tan}^{- 1} \frac{\sqrt{{x}^{2} + {y}^{2}}}{z} ,$$

is the azimuth angle (e.g. the angle between r and Z-direction as shown in FIGS. 1(b)-(c)), SAD is the distance from the source to the patient's isocenter (e.g. about 100 cm), and SID is the distance from the source to the imager (e.g. about 150 cm).

Therefore and as derived from equation (1), the marker's radial distance in the X-Y plane (ρ) is given by:

$$ρ = c \frac{1}{\frac{sin ( α - θ )}{j} + \frac{cos ( α - θ )}{SID}} \qquad ( 2 )$$

where

$$c = \frac{SAD}{SID} ,$$

which represents a scaling factor.

Using similarity of triangles in FIG. 1(c), the relationship between the marker's displacement along the z-axis (z) and the projection's 2D position along the k-axis (k) is given by:

$$\frac{SAD - r sin ( β ) cos ( θ )}{SID} = \frac{z}{k} \qquad ( 3 )$$

From equations (2) and (3), the relationship between the marker's 3D position (x, y, z) and the projection's 2D position (j, k) is given by:

$$x = ρ sin ( α ) = c \frac{sin ( α )}{\frac{sin ( α - θ )}{j} + \frac{cos ( α - θ )}{SID}} \\ y = ρ cos ( α ) = c \frac{cos ( α )}{\frac{sin ( α - θ )}{j} + \frac{cos ( a - θ )}{SID}} \\ z = ck ( 1 - \frac{ρ cos ( θ )}{SAD} ) \qquad ( 4 )$$

When a patient is static, his voxels are considered to be stationary such that their 3D position is consistent throughout the duration of the scanning period. As expected, a stationary voxel positioned at the patient's isocenter, e.g. voxel (0, 0, 0), may be projected onto the imager's isocenter, e.g. pixel (0, 0), over the entire scanning period. Further, stationary voxels positioned off-isocenter in the superior-inferior direction (i.e. displaced along the z-axis) may be projected onto the imager at a fixed position along the k-axis, e.g. (0, k), over the entire scanning period. However, stationary voxels that are not positioned along the z-axis, e.g. voxels positioned in the X-Y plane, may be projected onto the imager at varying positions over the scanning period. Put differently, the 2D position of a stationary voxel's projection may change over the scanning period (e.g. Δj, Δk), even though the stationary voxel's 3D position remains the same (i.e. for stationary voxels positioned on the X-Y plane). Specifically, the corresponding projection's displacement from the imager's isocenter (OBI isocenter) may vary sinusoidally in relation to the observation angle such that the projection's magnitude (e.g. the projection's maximum value during the scanning period) is proportional to the voxel's 3D displacement from the patient's isocenter, e.g. when the projections are adjusted by the appropriate scaling factor (e.g. c=SAD/SID).

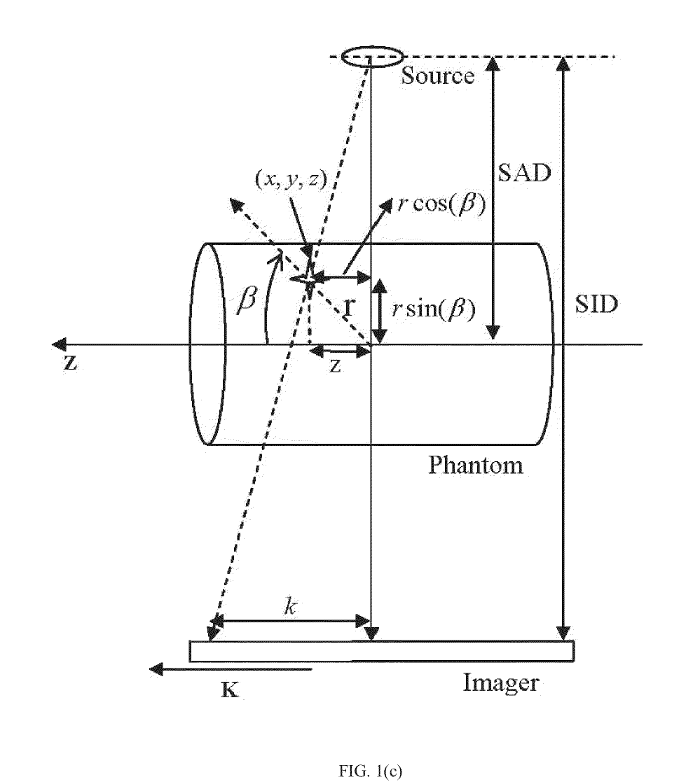

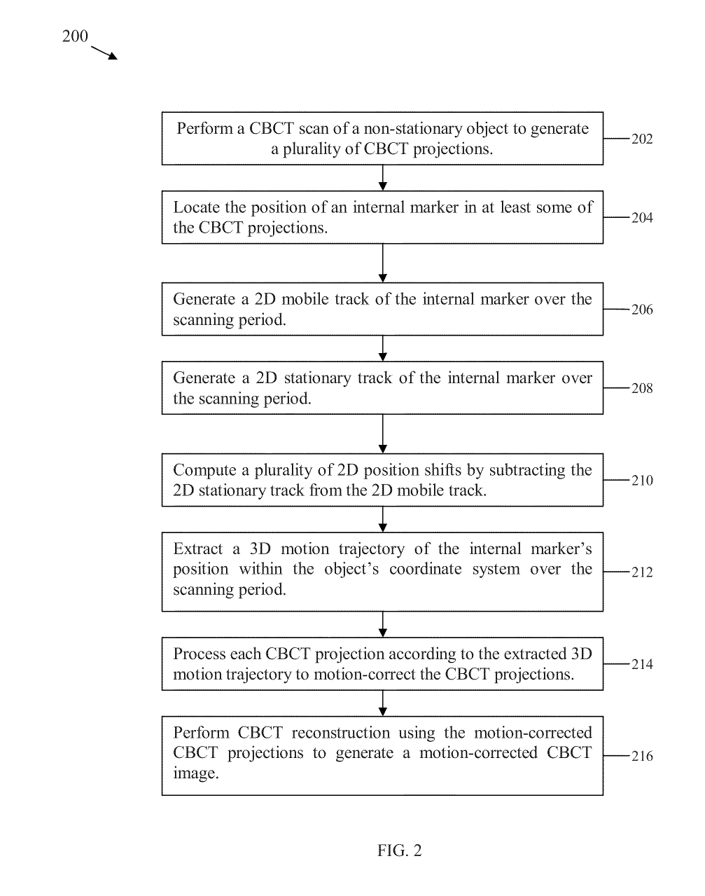

FIG. 2 illustrates an embodiment of a 3D motion trajectory extraction method 200, which may be used by an OBI and/or external computer to reduce motion related image artifacts in a CBCT image. At step 202, the OBI may perform a CBCT scan of a non-stationary object to generate a plurality of CBCT projections. In an embodiment, the OBI may generate about 650 CBCT projections over the course of an about one minute long scanning period. The CBCT scan may be performed using various radiation intensities, e.g. depending on the density of the observed internal structure, and according to various different scan modes, e.g. HF mode, FF mode, etc. At step 204, the OBI may locate the position of an internal marker in at least some of the CBCT projections. For instance, the OBI may employ a normalized cross-correlation algorithm to find the internal marker's position in the projections based on a template image of the internal marker (e.g. a template matching the internal marker's intensity, contrast, shape variation, etc.). In some embodiments, the internal marker may be captured in about half of the CBCT projections, e.g. when a HF scan mode is used. In other embodiments, the internal marker may be captured in about all of the CBCT projections, e.g. when a FF scan mode is used. At step 206, the OBI may generate a 2D mobile track of the internal marker over the course of the scanning period. The 2D mobile track may be a function of view angle (e.g. according to time-tagged angular views corresponding with the various CBCT projections), and may be generated based on at least some of the located internal marker positions, e.g. in some or all of the CBCT images. In some embodiments, the internal marker may not be captured in one or more, e.g. about half, of the CBCT projections, and hence some unknown data points in the 2D mobile track may be interpolated, e.g. via polynomial interpolation, from other known data points. At step 208, the OBI may generate a 2D stationary track of the internal marker over the scanning period. The 2D stationary track may be a function of view angle, and may be generated by applying a non-linear curve fitting algorithm to the 2D mobile track. In an embodiment, the 2D stationary track may correspond to the ideal projection of the internal marker's stationary position within the object's coordinate system, e.g. irrespective of the object's 3D displacement during the scanning period. At step 210, the OBI may compute a plurality of 2D position shifts by subtracting the 2D stationary track from the 2D mobile track, e.g. at each corresponding view angle. In some embodiments, the OBI may convert the 2D stationary track into a sinusoidal approximation prior to subtracting it from the 2D mobile track. The plurality of 2D position shifts may comprise the component of the 2D mobile track that is attributable to the object's displacement during the scanning period, while the 2D track may comprise the component of the 2D mobile track that is attributable to the object's ideal stationary position within the object's coordinate system. At step 212, the OBI may extract a 3D motion trajectory of the internal marker's position within the object's coordinate system over the scanning period. In an embodiment, the OBI may extract the 3D motion trajectory by converting the 2D position shifts into a transformation vector, e.g. (u, v), according to the corresponding view angles. For instance, the transformation vector, e.g. (u, v), may map the position of the internal marker at the various angular views for all CBCT projections. At step 214, the OBI may process each CBCT projection according to the extracted 3D motion trajectory to motion-correct the CBCT projections. In some embodiments, processing each CBCT projection may comprise transforming each CBCT projection based on the transformation vector and view angle, e.g. at the corresponding time-tagged angular view. At step 216, the OBI may perform CBCT reconstruction using the motion-corrected CBCT projections to generate a CBCT image.

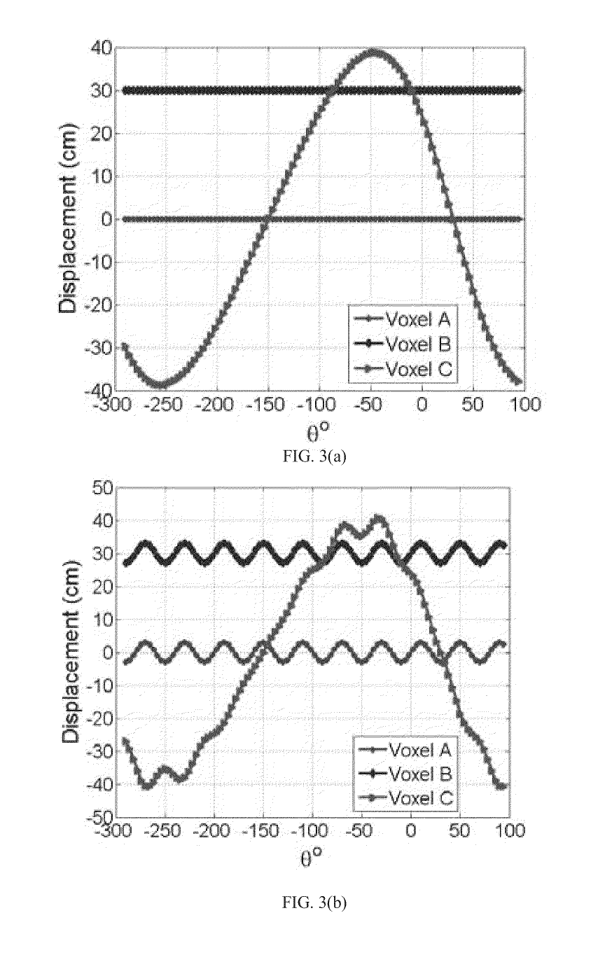

As detailed below, FIGS. 3(a)-(b), 4(a)-(d), and 5(a)-(c) illustrate graphical representations of simulations performed to illustrate some of the relationships described herein, e.g. geometric and mathematic relationships between voxels and pixels during CBCT scans. The simulations were conducted using a phantom mounted to a moving platform. The phantom was a CATPHAN 500 phantom, which is commercially available for purchase from phantom laboratory in Salem, N.Y. The CATHPAN 500 is a cylindrically shaped object comprising a diameter of about 20 cm and a length of about 20 cm. The CATHPAN 500 contains several modules that may be used to evaluate image quality parameters of CBCT reconstruction before and after motion correction, e.g. CT number uniformity and linearity, contrast, and spatial resolutions. The moving platform comprised a flat polystyrene surface attached to the arm of a driving motor. The driving motor comprised adjustable amplitude and frequency settings to mimic patient respiratory motion, which were set at fifteen cycles per minute (cycles/min) and 1.75 cm, respectively. Attached to the CATHPAN were standard metallic seed markers of uniform dimension (1 mm diameter, 2 mm length), which were visible with high contrast in the resulting radiographic projections.

FIG. 3(a) illustrates a sinogram of three stationary voxels (e.g. voxel-A, voxel-B, and voxel-C) projected onto an imager. A sinogram may comprise a graphical representation of a projection's displacement from OBI isocenter as a function of view angle. Specifically, voxel-A may be positioned at patient isocenter, e.g. (0, 0, 0), voxel-B may be displaced 20 cm from patient isocenter along the Z-axis, e.g. (0, 0, 20), and voxel-C may be displaced 20 cm from patient isocenter along the X-Y plane, e.g. (x′, y′, 0) where (x′)²+(y′)²=20². As shown, the projections of voxel-A and voxel-B remain a fixed distance from OBI isocenter across all view angles, while the projection of voxel-C varies sinusoidally in relation to OBI isocenter as a function of view angle. As such, stationary voxels may be projected onto the flat panel projector in a consistent and predictable fashion over the scanning period.

On the other hand, non-stationary voxels, e.g. resulting from patient motion, may be projected in a less predictable fashion, causing positional offsets in the corresponding projections as well as superimpositions within resulting sinograms. FIG. 3(b) illustrates how a sinusoidal respiration track, e.g. with a displacement amplitude of about two cm and a frequency of about twelve hertz (HZ), affects the sinogram of the three stationary voxels of FIG. 3(a). As shown, cyclical patient motion, e.g. a sinusoidal respiratory track, may be reflected as a motion component in the resulting sinogram.

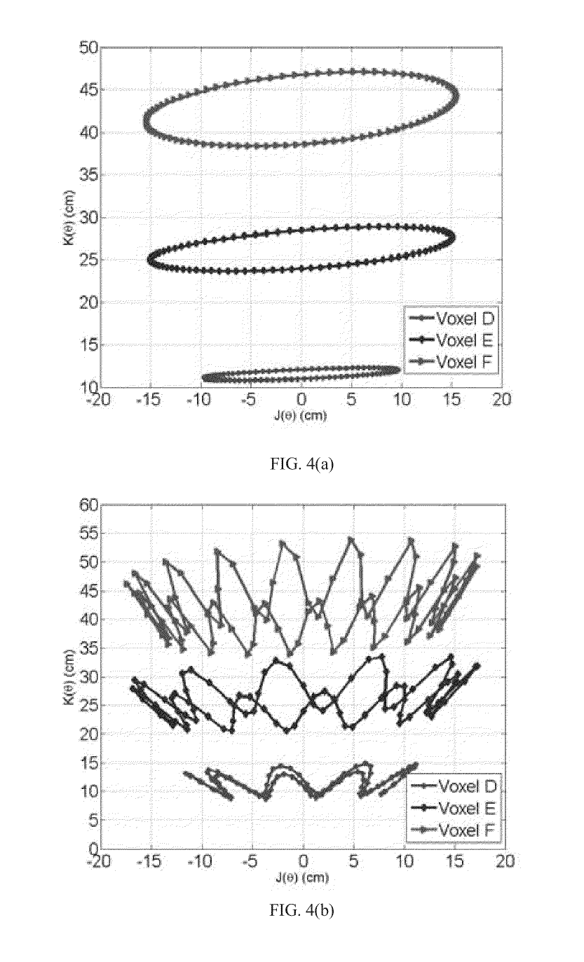

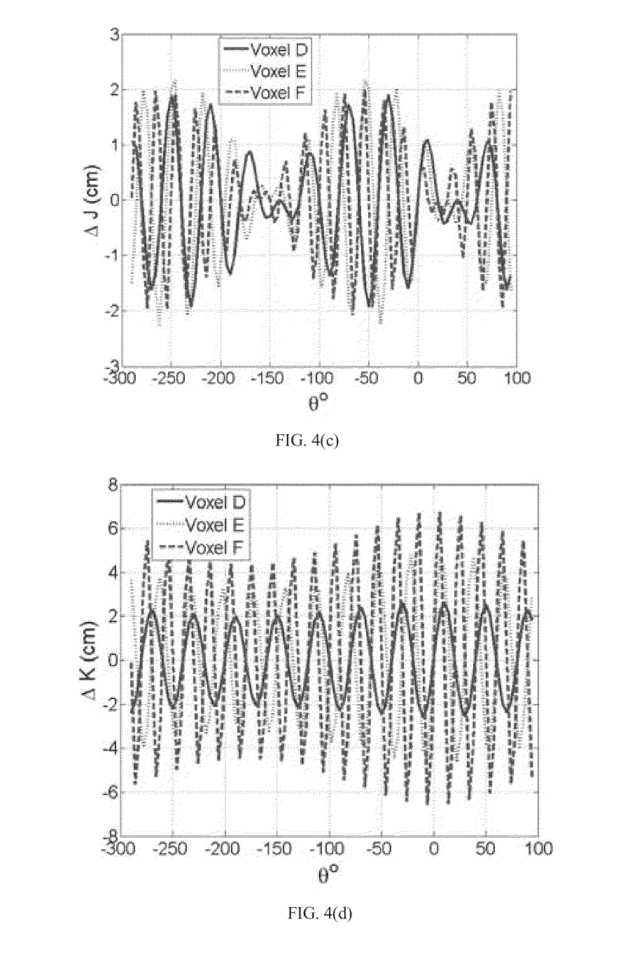

The 2D position of a stationary voxel projection may create a closed elliptical track when the projection's displacement along the K-axis is plotted as a function of the projection's displacement along the J-axis, e.g. when the J-K position is plotted. FIG. 4(a) illustrates the J-K positions of three stationary voxel projections. Specifically, the three stationary voxels include voxel-D, voxel-E, and voxel-F comprising spherical coordinates, e.g. (radial distance (r), polar angle (α), azimuth angle (β)), of (10, 40, 40), (20, 30, 30), and (30, 20, 20), respectively. FIG. 4(b) illustrates the J-K positions of three non-stationary voxel projections. Specifically, the three stationary voxels comprise non-stationary voxel-D, non-stationary voxel-E, and non-stationary voxel-F which may correspond to voxel-D, voxel-E, and voxel-F as influenced by a simulated cyclical motion comprising an amplitude component (i.e. amplitudes of 2 cm, 3 cm, and 4 cm, respectively) and frequency component (i.e. frequencies of 9 Hz, 12 Hz, and 18 Hz, respectively). The simulated cyclical motion may approximately mimic patient respiratory motion.

The net displacements attributable to the simulated cyclical motion, e.g. (Δj, Δk), may be extracted from the data by subtracting the displacements of the stationary tracks, e.g. (jₛ, kₛ), from the displacements of the mobile tracks, e.g. (jₘ, kₘ). FIG. 4(c) illustrates a simulation where net displacement (Δj) attributable to the cyclic motion along the J-axis is extracted for non-stationary voxel-D, non-stationary voxel-E, and non-stationary voxel-F. FIG. 4(d) illustrates a simulation where net displacement (Δk) attributable to the cyclic motion along the k-axis is extracted for non-stationary voxel-D, non-stationary voxel-E, and non-stationary voxel-F.

In practice, the OBI may extract a marker's mobile track from a series of CBCT projections by employing a normalized cross-correlation image registration algorithm to locate the position in each projection. Specifically, the algorithm may compare the intensity of a marker's template image, e.g. T(x, y), with a ROI in each projection, e.g. I(x,y), to identify a position of maximum correlation and/or overlap. Identifying the position of maximum correlation and/or overlap may comprise registering the template with similar objects within the ROI, and determining which of those objects best match the template's intensity and shape. In some embodiments, the error in localization of a marker position may be about ±0.5 pixels (or about ±0.13 mm at isocenter). By tracking the marker's position in each of the projections, the OBI may identify the marker's mobile track (jₘ, kₘ) over the scanning period.

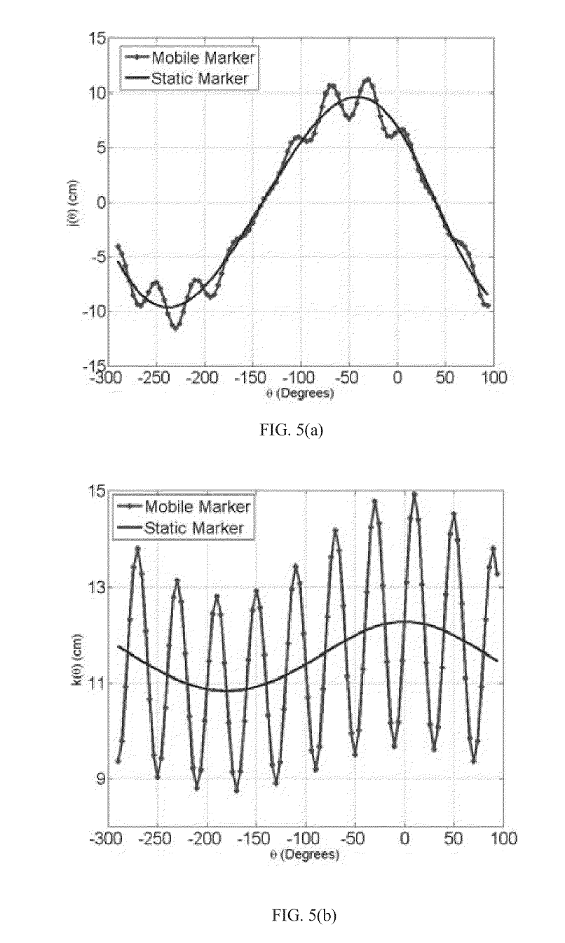

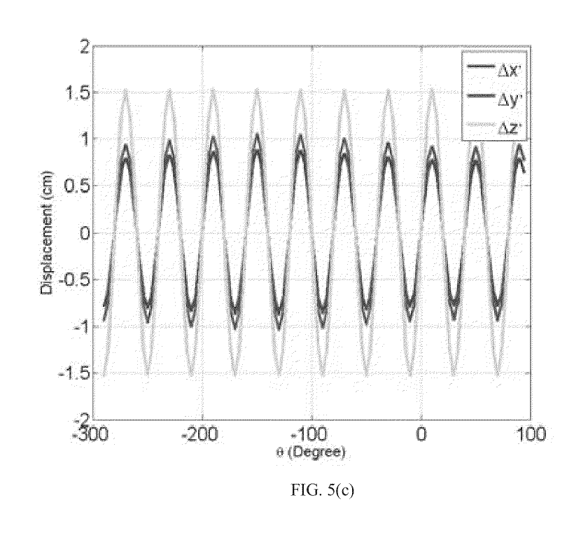

Subsequently, the OBI may extract the marker's stationary track (jₛ, kₛ) from the marker's mobile track by applying a non-linear curve fitting algorithm, such as the Levenberg-Marquardt method. FIGS. 5(a) and 5(b) illustrate how a marker's stationary track compares with a marker's mobile track. After extracting the marker's stationary track, the OBI may find the stationary track's corresponding spherical coordinates, e.g. [jₛ(r, α, β), kₛ(r, α, β)], according to a best fitting parameter of the marker's stationary track. In some embodiments, one or more of the spherical coordinates may be fitted to the stationary track using one or both of the following equations:

$${j}_{s} ( r , α , β ) = c \frac{1 - r sin ( β ) cos ( α - θ ) / SAD}{r sin ( β ) sin ( α - θ )} \\ {k}_{s} ( r , α , β ) = c \frac{1 - r sin ( β ) cos ( θ ) / SAD}{r cos ( β )} \qquad ( 5 )$$

The net motion components (Δx′, Δy′, Δz′) in the patient's coordinate system may be extracted by subtracting the marker's stationary position, e.g. (xₛ, yₛ, zₛ), from the marker's mobile position, e.g. (xₘ, yₘ, zₘ). In some embodiments, the net motion components (Δx′, Δy′, Δz′), e.g. as derived from equation (4), may be computed according to the following equation:

Δx′=x(jₘ)−x(jₛ)

Δy′=y(jₘ)−y(jₛ)

Δz′=z(kₘ)−z(kₛ) (6)

FIG. 5(c) illustrates the net motion components in the different directions. A sinusoidal approximation of each marker's net motion component may be computed applying a best fitting parameter to the marker's net motion component, e.g. to determine a corresponding amplitude, frequency, and phase parameter. The sinusoidal approximation may be computed according to:

Δx′=Aₓ·sin(2πfₓ−δₓ)

Δy′=A_{y}·sin(2πf_{y}−δ_{y})

Δz′=A_{z}·sin(2πf_{z}−δ_{z}) (7)

where Aₓ, A_{y} and A_{z} are motion amplitudes, fₓ, f_{y} and are motion frequencies and δₓ, δ_{y} and δ_{z} are phases in patient coordinate system in the X, Y, and Z-directions, respectively.

In some embodiments, the OBI may apply an algorithm, e.g. based on one or more of the above equations, to track each marker's motion in three-dimensional space. For instance, the algorithm may calculate each marker's six-degrees of freedom, e.g. according to one or more of the equations above, for the purpose of tracking the marker's trajectory in the patient coordinate system. In some embodiments, the trajectory of each marker may be used to correct motion in CBCT reconstruction, e.g. by extracting motion in CBCT projections prior to CBCT reconstruction, thereby improving the quality of the resulting 3D image.

The OBI may track the motion and/or trajectory of one or more markers, e.g. two interior markers and an exterior marker, for purposes of correcting motion in CBCT scans. For instance, the OBI may extract position shifts attributable to patient motion (Δj, Δk) from a sinogram of an internal marker. The internal marker's position shifts then may be used to compute a transformation vector (u, v) that may be used to map the position of an external marker at the various angular views for some or all of the CBCT projections. Subsequently, the OBI may shift some or all of the projection's pixels, e.g. each of the pixels in the ROI, according to the transformation vector and corresponding view angle (e.g. time-tagged view angles). For instance, position shifts along the J-axis of a CBCT projection corrects for marker motion in the X-Y plane of the patient coordinate system, while position shifts along the K-axis of a CBCT projection correct for marker motion along the Z-axis of the patient coordinate system. The resultant 2D-intensity map, e.g. I′(Jₛ, Kₛ, θ), of the transformed radiographic projection at angular view (θ) may be given by:

I′(jₛ,kₛ,θ)=I(jₘ−u,kₘ−v,θ) (8)

The OBI may use the transformed radiographic projections (I′) as input parameters during CBCT reconstruction, e.g. based on a Feldkamp back-projection algorithm as provided by the OBI vendor (e.g. Varian Medical Systems), to remove motion from CBCT images. In some embodiments, the transformed radiographic projections may be processed off-line by an external computer, e.g. running MATLAB. For instance, off-line processing of 650 projection images to extract a 3D motion trajectory may take around three minutes for computers, e.g. personal computers (PC), comprising a modern processor, e.g. an Intel® Core™ Solo Processor U1400 a 1.2 Gigahertz (GHz) clock rate and 1-Gigabyte of random access memory (RAM).

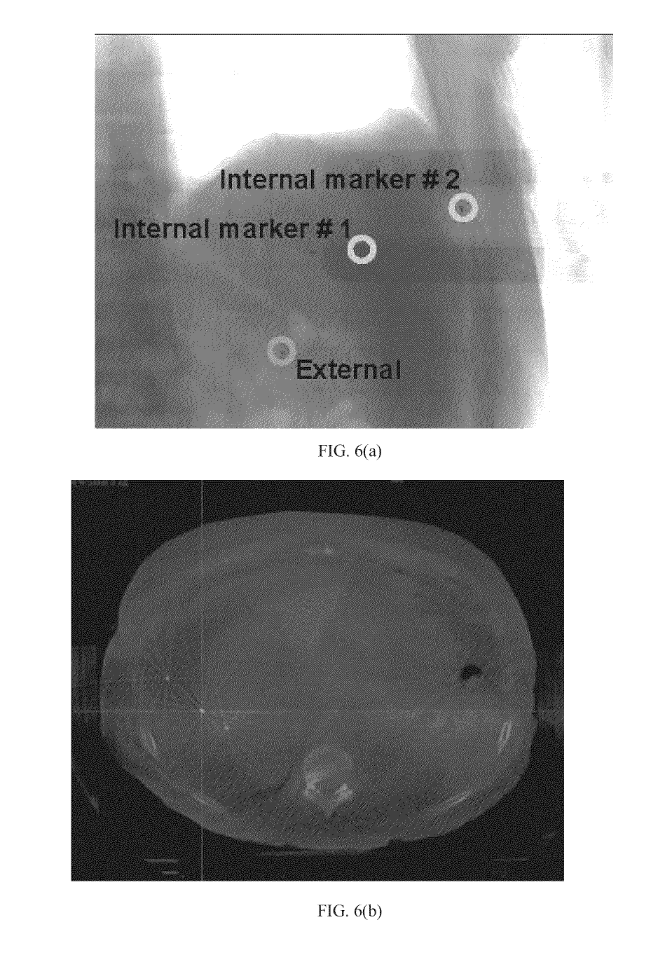

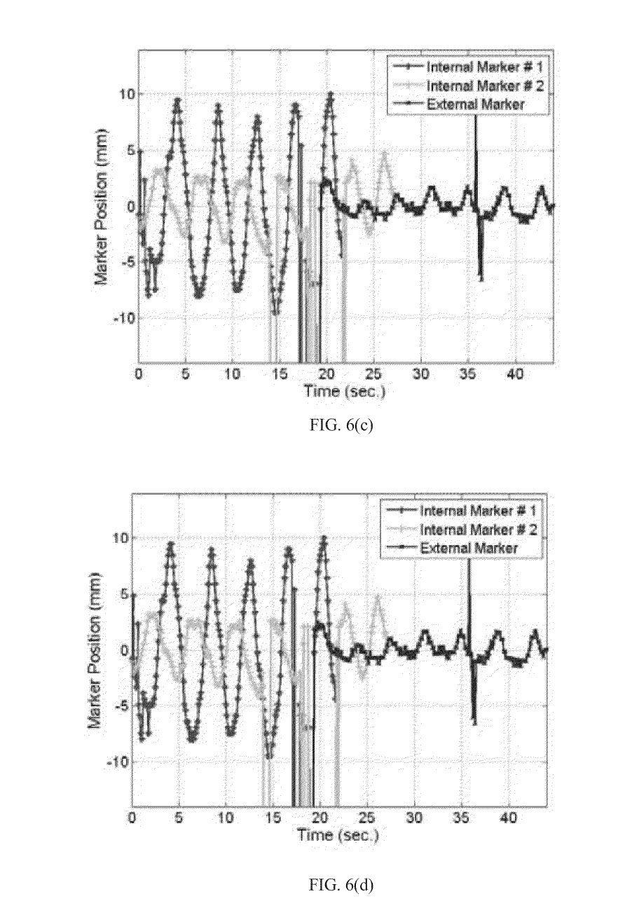

The principles described above were used to investigate seed marker motion in four patients with liver masses. Each patient was implanted with two or three seed markers, which were positioned in and around the lesion area. These patients were treated with six fractions (five gray units (Gys) of absorbed radiation per fraction) using intensity modulated radiation therapy (IMRT). A projection and a CBCT slice are displayed, in FIGS. 6(a) and 6(b) (respectively), showing the approximate positions of two internal markers implanted inside a patient and one external marker attached to the patient's skin, which were used as surrogates for tumor localization and motion tracking, respectively. Each marker's motion was tracked by retrospectively measuring the marker shifts in CBCT radiographic projections acquired over a scanning period lasting approximately one minute. Depending on the location of the seed markers implanted in the patient, the extracted motion track of a marker may include about seven to twelve respiratory cycles from the projections of one CBCT scan.

FIGS. 6(c) and 6(d) show the motion tracks of two internally implanted seed makers and an external marker attached to the skin of a liver patient. Position shifts in FIG. 6(c) represent the motion of internal and external markers along the z-axis (superior-inferior direction). The curves in FIG. 6(d) represent marker motion in X-Y plane. These motion tracks were extracted from the projections acquired from a CBCT scan using a HF scanning mode. According to FIGS. 6(c) and 6(d), patients may have between about ten and about fifteen respiratory cycles in one minute when breathing regularly. The number of respiratory cycles obtained from CBCT projections depends on the position of the marker relative to the OBI's isocenter as well as the scanning mode used. In HF scans, the beam only passes through half of the ROI (i.e. half of the patient) at any given time, thus the markers appear only in projections capturing the side of the patient in which the marker is placed. As illustrated in FIGS. 6(c) and 6(d), about five respiratory cycles were obtained for internal marker #1, about seven respiratory cycles for internal marker #2, and about seven respiratory cycles were obtained for the external marker. During the scans, internal marker #1 and internal marker #2 where positioned on the patient's right side, while the external marker was positioned on the patient's left side. Accordingly, each of the markers appeared in approximately half of the CBCT projections, and as a result their positions were interpolated for those CBCT projections in which they did not appear. When using FF scans (e.g. having diameters in excess of 25 cm), the entire ROI is captured at all times during the scan such that the markers show up in each projection. In some embodiments, FF scans may allow for more accurate motion compensation than HF scans.

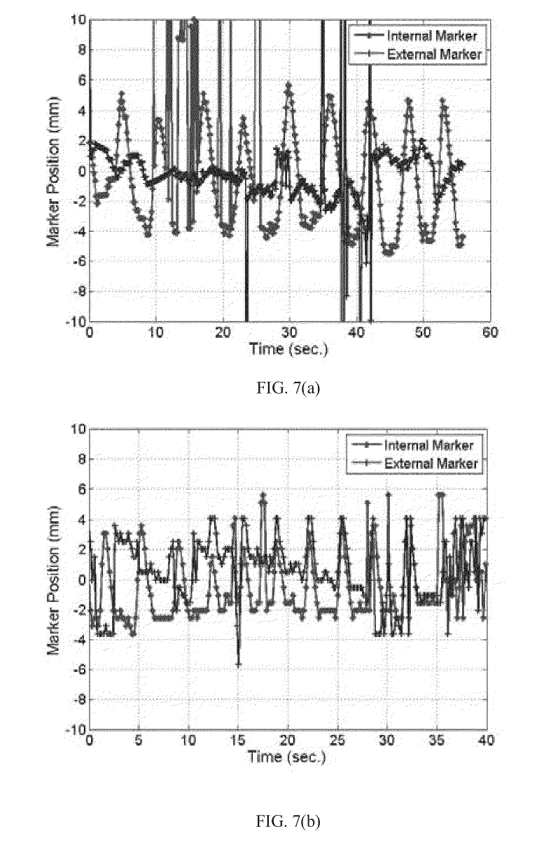

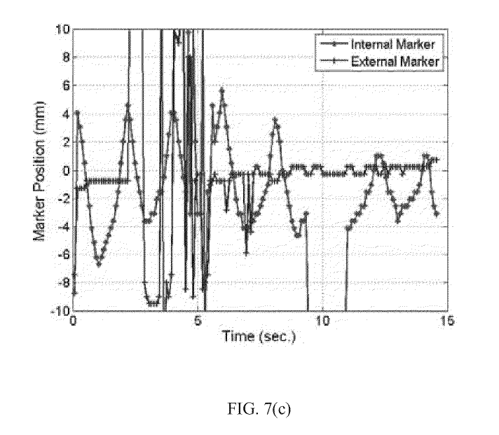

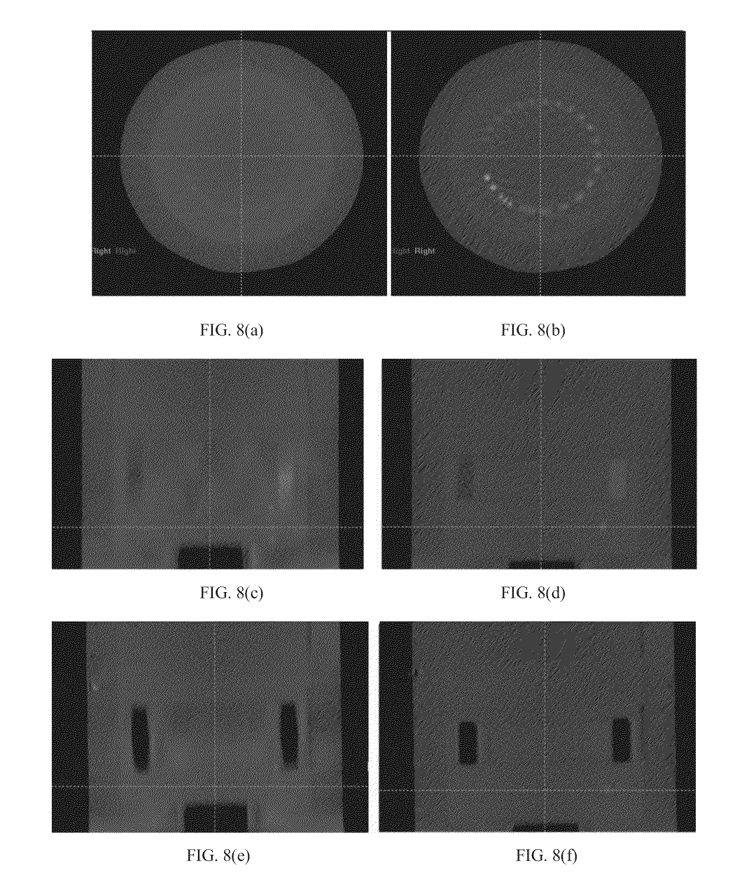

The external and internal marker motion tracks for the first patient, as shown in FIGS. 6(c) and 6(d), have the same frequency of respiration. However, each of the internal markers have different motion amplitudes. Specifically, the internal marker #1 (located close to the patient's chest wall) had an amplitude of approximately three mm, while the internal marker #2 (located close to the patient's diaphragm) had an amplitude of approximately nine mm. The external marker (attached to patient's skin) had an amplitude of approximately 1.5 mm, which was less than that of the internal markers. Additionally, the external marker's motion track was out of phase with the internal markers. The internal and external marker motion of the second patient and forth patient, as illustrated in FIGS. 7(a) and 7(c) (respectively), were not correlated. Approximately half of the patients observed (i.e. two out of four patients studied) had correlated external and internal marker motions. In each of the patients observed, the external marker's motion amplitude was less than that of the internal markers. FIGS. 6(c) and 6(d) illustrate outlier points on the measured data curve of motion shifts at around 36 seconds. These points and others, e.g. in FIGS. 6 and 8, appeared where the tracking algorithm fails to detect the shadow of the metal marker in the corresponding radiographic projections. This failure of the algorithm to detect the metal marker was due to the existence of shadows that may have similar intensity-gradient features as the marker in these particular radiographic projections. This problem was resolved using polynomial interpolation to predict patient motion in angular views in which the seed markers are not captured by the CBCT projection. The interpolated motion track accurately predicts cyclic respiratory motion, but does not account for non-cyclical patient motion, such as patient relaxation or sudden motion because polynomial interpolation cannot predict non-cyclical and/or aperiodic motion. As such, the motion of external markers may not correlate fully with internal marker motion. For instance, the motion correlation pattern may vary from one patient to another, and the motion amplitudes and phases of the internal and external markers may vary within the same patient. For example, the motion tracks of the first patient, as illustrated in FIGS. 6(c) and 6(d), demonstrate that the internal marker motion varies in amplitude as well as phase from the external marker. The motion amplitude of an internal marker close to the diaphragm is four times larger than the external marker in the superior-inferior direction, as illustrated in FIG. 6(c).

Tracking the motion of internal markers may provide numerous advantages over traditional RPM systems, which may only track external markers attached to the patient's skin. For instance, the motion tracks obtained from the internal markers may provide 3D motion components of the examined area (or portions thereof), while traditional RPM systems may only provide a 1D motion component, e.g. a non-calibrated anterior-posterior motion component. Additionally, the motion tracks obtained from the internal and external markers may be correlated, e.g. in some patients, and may be used as a baseline for further patient motion monitoring and/or tracking.

In some embodiments, a radiographic correlation between the internal marker motion and the external maker motion may be established by considering differences in each marker's amplitude and phase across a series of CBCT projections. Subsequently, the external marker may be tracked using non-radiographic methods, e.g. infrared imaging, surface imaging, etc., for purposes of tumor motion monitoring, tracking, and/or beam gating. For instance, in arc radiotherapy, the internal marker motion may be extracted directly from kV CBCT projections and used for real time tumor tracking, and/or imaging during treatment.

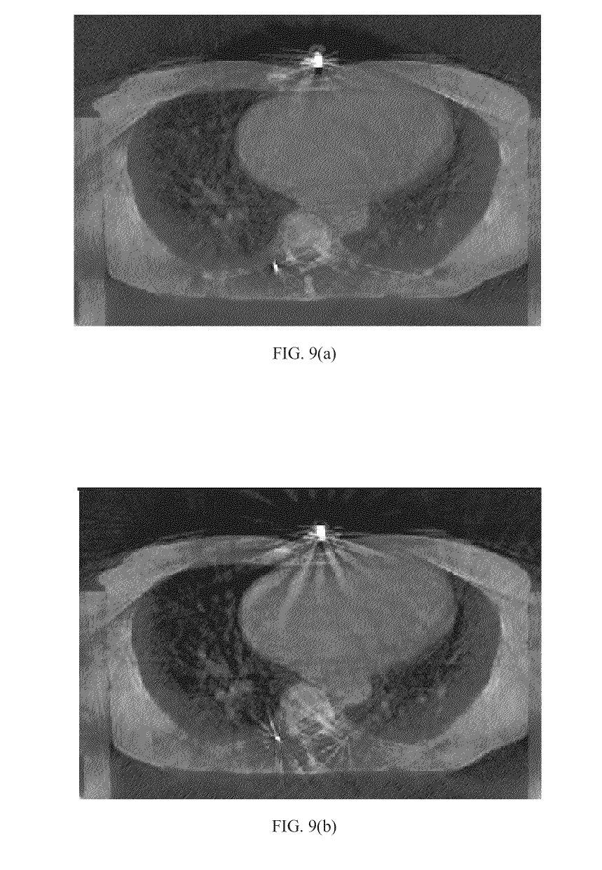

FIGS. 8 and 9 illustrate how internal and external marking tracking may result in improved image quality during CBCT reconstruction. For instance, the CBCT images constructed using corrected projections, as depicted in FIGS. 8(b), 8(d), 8(f), and 9(b), show significantly improved image quality, e.g. resolution, sharpness, etc., when compared to corresponding CBCT images reconstructed using uncorrected projections, as depicted in FIGS. 8(a), 8(c), 8(e) and 9(a) (respectively). Specifically, correction of CBCT projections using internal marker tracking reduced various motion related image artifacts, such as blurring, object spatial distortion, and poor contrast, as well as increased spatial resolution. Lung border line and nodals were less blurred in CBCT images reconstructed from projections that were corrected for respiratory motion, e.g. via internal marker tracking. In contrast, RPM-corrected reconstructed CBCT images may contain significant residual motion related image artifacts because the projections are corrected in groups according to respiratory phase (rather than individually). Specifically, respiratory phases do not represent stationary states (i.e. shifting due to marker motion occurs within the respiratory phase), and thus the transformation used to correct each projection is incapable of optimally compensating for shifting in that particular projection.

Conversely, the techniques disclosed herein actually correct for measured shifts in each CBCT projection. Specifically, CBCT projections are mapped onto a semi-stationary position in which the motion amplitude is zero instead of capturing the projections at different phases followed by reconstruction of CT at one phase or the other as it is done in phase-sorted 4D-CT. Another advantage of using projection mapping is that all projections from different angular views are used in the construction of motion-corrected CBCT. However, 4D-CBCT reconstructed from sorted projections include only the projection acquired in a certain respiration phase, which limits its image quality.

In an embodiment, one or more of the techniques applied herein may assume that the patient body, or portions thereof, move as a rigid body, even though that might not necessarily be true for each application. Nonetheless, the assumption may not significantly affect image quality because portions of the body projected into the ROI, e.g. portions surrounding the seed marker and/or lesion, may move similarly to the marker. Hence, anatomical mapping based on marker motion may be accurate for the ROI surrounding the seed marker and/or tumor. In some embodiments, the motion of an internal marker implanted into the ROI may be used to compensate for motion during CBCT reconstruction, rather than the motion of an external marker (which may be out of phase). In other embodiments, the motion of multiple markers, e.g. two internal markers and an external marker, may be used correct for patient motion. For instance, multiple markers placed within the same or different ROIs may be used to correct motion locally (e.g. in different regions of the projections) by shifting pixels according to the most proximately positioned marker. Alternatively, the multiple markers may be placed within a single ROI, and the markers' motions may be averaged to determine an optimal shift, e.g. to uniformly apply to all pixels within the ROI. As such, the techniques disclosed herein may correct for patient motion using the actual measured motion of one or more markers. Alternatively still, pixels may be shifted according to a weighted average that depends on the pixel's proximity to both of the markers, e.g. according to a gradient.

The above disclosed techniques may also be performed using various marker-less tracking methods and/or approaches, e.g. fluoroscopic imaging, radiographic projections, external skin surface imaging, respiratory sensor monitoring, etc. One or more of these methods may avoid risks and/or drawbacks associated with marker implantation, such as pneumothorax and/or marker migration, by tracking various marker surrogates, e.g. anatomical surrogates, surface features, air flow of the patient, etc. However, marker-less tracking techniques may be less precise than techniques using implanted internal markers, and thus may provide insufficient motion correlation (e.g. between the surrogate and the tumor) for some applications. For instance, surrogate projections may have less contrast, limited border definition, and shape variation than marker projections. Hence, implanted markers, e.g. metal markers, may be projected with higher contrast and/or resolution with similar features being captured by many different projections (e.g. from different angular views), and therefore may be more compatible with automatic tracking algorithms. Additionally, the motion of internal markers may vary depending on the location of the markers, e.g. as shown in FIGS. 6(c) and 6(d). For instance, the motion amplitudes of the internal markers implanted close to the diaphragm may be larger than that of markers implanted further away from the diaphragm. Hence, internal markers (unlike their surrogate counterparts) may be positioned at locations within the ROI that more accurately map the motion amplitude, phase, and variation of the targeted tumor. Thus, automated marker tracking techniques that trace small and/or well-defined internal markers may provide greater accuracy than techniques tracing anatomical surrogates.

In some embodiments, blind spots may result from marker motion components occurring in a plane parallel to the central axis (CAX) line. However, these motion components may not influence image quality, and hence correction for such motion components may not be required to reconstruct motion-free CBCT images using some algorithms and/or techniques, such as those disclosed herein. Additionally, blind spots in one angular view are likely to be recovered in other angular views, and thus the marker motion track may not be meaningfully altered as a result of the blind spot. Additionally, FF scanning modes can be used to ensure that the entire ROI, e.g. including the tumor and seed markers, is captured in each projection. Some embodiments may extend one or more of the disclosed techniques to additional dimensions, e.g. to perform 4D-CBCT. Some embodiments may use the amplitudes of motion trajectories, e.g. extracted in real-time, to define accurate treatment margins and/or planning targets just prior to dose delivery, e.g. particularly when performing certain adaptive radiation therapies. The techniques disclosed herein may not require additional doses of radiation beyond that required for CBCT imaging, and consequently may have reduced radiation exposure when compared to comparable radiographic techniques, such as fluoroscopy. In some CBCT scans, imaging shifts attributable to a sagging of the heavy linac gantry during its rotation around the patient may occur, causing a small displacement to be added to each projection. Some embodiments may correct for sagging imaging shifts by subtracting the corresponding displacements from the sinogram of each seed marker, thereby increasing accuracy and/or image quality of the resulting CBCT image.

The techniques disclosed herein may be used to design algorithms for extracting 3D internal and external marker motions from CBCT projections. Some applications may correlate the motion frequency of internal and external marker motions with one another, even though some markers may have different motion amplitudes and/or phases, e.g. as was observed in the liver patients. For instance, 3D motion of internal seed markers may correspond to actual tumor motion resulting from respiratory function, and may enable more accurate patient setup during radiation therapy procedures, e.g. image-guided radiation therapy procedures, as well as sub-real time prediction of tumor motion trajectories, e.g. just prior to patient treatment. The marker motion tracks from CBCT projections may provide motion information that may be compared and/or correlated with the motion of other external markers, e.g. RPM infra-red signal markers, to test internal and external marker correlation and validation, e.g. during beam gating and/or tumor tracking procedures. In some embodiments, internal marker motion may be extracted directly from CBCT projections and used for imaging, e.g. on-line tumor tracking, during radiation therapy treatment, e.g. during arc therapy. As such, the techniques disclosed herein may be employed to track and correct marker motion in CBCT projections prior to reconstruction, thereby eliminating and/or reducing motion related image artifacts, such as blurring, spatial distortion, poor contrast and position resolutions.

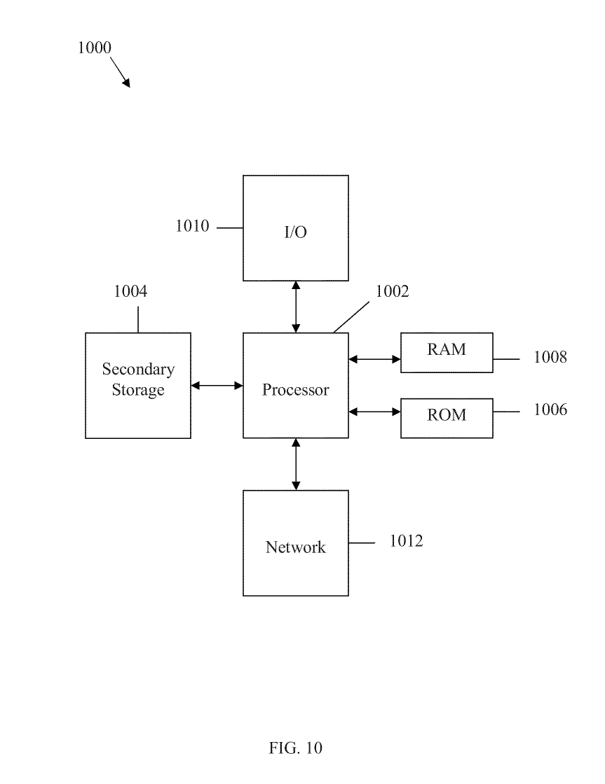

One or more of the techniques described above, e.g. processing of projections, extraction of 3D motion trajectories, etc., may be implemented on a general-purpose network component, such as a computer or network component with sufficient processing power, memory resources, and network throughput capability to handle the necessary workload placed upon it. FIG. 10 illustrates a typical, general-purpose network component suitable for implementing one or more embodiments of a node disclosed herein. The network component 1000 includes a processor 1002 (which may be referred to as a central processor unit or CPU) that is in communication with memory devices including secondary storage 1004, read only memory (ROM) 1006, random access memory (RAM) 1008, input/output (I/O) 1010 devices, and network connectivity devices 1012. The processor may be implemented as one or more CPU chips, or may be part of one or more application specific integrated circuits (ASICs) and/or digital signal processors (DSPs).

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs that are loaded into RAM 1008 when such programs are selected for execution. The ROM 1006 is used to store instructions and perhaps data that are read during program execution. ROM 1006 is a non-volatile memory device that typically has a small memory capacity relative to the larger memory capacity of secondary storage 1004. The RAM 1008 is used to store volatile data and perhaps to store instructions. Access to both ROM 1006 and RAM 1008 is typically faster than to secondary storage 1004.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising a processor configured to:
receive a sequence of Cone-Beam Computed Topology (CBCT) projections of a three dimensional (3D) object over a scanning period, wherein the 3D object is displaced during the scanning period, and wherein each of the CBCT projections is associated with a discrete point during the scanning period;
locate a marker position in a plurality of the CBCT projections, wherein each marker position corresponds to the location of an internal marker at the corresponding discrete point during the scanning period;
extract a 3D motion trajectory based on the plurality of marker positions and a plurality of time-tagged angular views; and
correct the CBCT projections based on the 3D motion trajectory.

2. The apparatus of claim 1, wherein correcting the CBCT projections comprises transforming each CBCT projection according to a transform function that is unique to that CBCT projection.

3. The apparatus of claim 2, wherein the transform function corresponds to a displacement of the internal marker in the object's coordinate system at the corresponding discrete point during the scanning period, and wherein the displacement of the internal marker is correlated with the displacement of the 3D object.

4. The apparatus of claim 1, wherein the processor is further configured to:
generate a 2D mobile track (jₘ, kₘ) based on the plurality of marker positions;
generate a 2D stationary track (jₛ, kₛ) based on the 2D mobile track (jₘ, kₘ);
compute a plurality of 2D position shifts (Δj, Δk) based on the 2D mobile track (jₘ, kₘ) and the 2D stationary track (jₛ, kₛ); and
compute a transformation vector (u, v) based on the plurality of 2D position shifts (Δj, Δk),
wherein the 3D motion trajectory corresponds to a plurality of transformation functions (I) that are generated based on the transformation vector (u, v) as a function of view angle (θ).

5. The apparatus of claim 4, wherein the 2D mobile track (jₘ, kₘ) comprises a plurality of data points at least some of which correspond to the plurality of marker positions, and wherein any data points that do not correspond to a marker position are interpolated from data points that do correspond to the plurality of marker positions.

6. The apparatus of claim 4, wherein generating the 2D stationary track (jₛ, kₛ) comprises applying a non-linear curve fitting algorithm to the 2D mobile track (jₘ, kₘ).

7. The apparatus of claim 6, wherein computing the plurality of 2D position shifts (Δj, Δk) comprises subtracting the 2D stationary track (jₛ, kₛ) from the 2D mobile track (jₘ, kₘ).

8. The apparatus of claim 6, wherein computing the plurality of 2D position shifts (Δj, Δk) comprises subtracting a sinusoidal approximation of the 2D stationary track [jₛ(r, α, β), kₛ(r, α, β)] from the 2D mobile track (jₘ, kₘ), and wherein the sinusoidal approximation of the 2D stationary track [jₛ(r, α, β), kₛ(r, α, β)] comprises a first directional component [jₛ(r, α, β)] and a second directional component [kₛ(r, α, β)].

9. The apparatus of claim 8, wherein the first directional component [jₛ(r, α, β)] and the second directional component [kₛ(r, α, β)] are computed by finding a best fitting parameter of the 2D stationary track (jₛ, kₛ) according to equations:
$${j}_{s} ( r , α , β ) = c \frac{1 - r sin ( β ) cos ( α - θ ) / SAD}{r sin ( β ) sin ( α - θ )}$$
$${k}_{s} ( r , α , β ) = c \frac{1 - r sin ( β ) cos ( θ ) / SAD}{r cos ( β )}$$
where r is a radius of the internal marker in the object's coordinate system, where α is a polar angle of the internal marker in the object's coordinate system, where β is an azimuth angle in the object's coordinate system, where θ is a projection view angle, where SAD is a distance from a source to the object's isocenter, where SID is the distance from the source to a flat-panel imager, and where c is a scaling factor that is equal to about SAD/SID.

10. The apparatus of claim 1, wherein locating the marker positions comprises using a normalized cross-correlation image registration algorithm to find a position of maximum correlation within one or more of the CBCT projections, and wherein a marker position is located in at least about half of the CBCT projections.

11. The apparatus of claim 1, wherein the internal marker comprises a metal seed marker implanted within the 3D object.

12. A method comprising:
performing a Cone-Beam Computed Topology (CBCT) scan of a three dimensional (3D) object during a scanning period to produce a plurality of CBCT projections, wherein each CBCT projection comprises a snapshot of the 3D object taken from a unique view angle at a discrete point during the scanning period, and wherein the 3D object moves during the scanning period;
tracking the movement of a first internal marker over the scanning period, wherein the first internal marker is within the 3D object, and wherein the movement of the first internal marker corresponds with the movement of the 3D object during the scanning period;
correcting each CBCT projection based on the movement of the first internal marker at the corresponding discrete point during the scanning period; and
reconstructing a CBCT image using the corrected CBCT projections.

13. The method of claim 12 further comprising tracking the movement of a second internal marker over the scanning period, wherein the second internal marker is implanted within the 3D object in a different location than the first internal marker.

14. The method of claim 13, wherein both the first internal marker and the second internal marker comprise a metal seed marker.

15. The method of claim 13, wherein the first internal marker's frequency and phase correlates with the second internal marker's frequency and phase, wherein the first internal marker's amplitude is not equal to the second internal marker's amplitude, and wherein correcting the CBCT projections is further based on the movement of the second internal marker.

16. The method of claim 15, wherein correcting each CBCT projection comprises:
shifting pixels located proximate to the first internal marker according to the movement of the first internal marker, and
shifting pixels located proximate to the second internal marker according to the movement of the second internal marker.

17. The method of claim 16, wherein correcting each CBCT projection comprises shifting pixels according to an averaged movement, and wherein the averaged movement is computed by averaging the first internal marker's amplitude and the second internal marker's amplitude at the corresponding discrete point during the scanning period.

18. The method of claim 17, wherein the averaged movement is weighted according to the shifted pixel's proximity to both the first internal marker and the second internal marker.

19. The method of claim 15 further comprising tracking the movement of an external marker over the scanning period, wherein the external marker is attached to the surface of the 3D object, wherein the external marker's frequency and phase correlates with that of the first internal marker and that of the second internal marker, and wherein the external marker's amplitude does not equal that of either the first internal marker or the second internal marker.

20. The method of claim 19, wherein correcting the CBCT projections is further based on the movement of the external marker.
